(19) United States
(12) Patent Application Publication
(10) Pub. No.: US 2009/0037025 A1
(43) Pub. Date: Feb. 5, 2009

(54) Controller for robot having robot body and additional mechanism providing additional operation axes

(75) Inventor: Tomoya Yamamoto, Chita-gun (JP)

Correspondence Address: OLIFF & BERRIDGE, PLC, P.O. BOX 320850, ALEXANDRIA, VA, 22320-4850, US

(73) Assignee: DENSO WAVE INCORPORATED, Tokyo (JP)

(21) Appl. No.: 12/219,913

(22) Filed: Jul. 30, 2008

(30) Foreign Application Priority Data
Jul. 30, 2007 (JP) 2007-197439

(51) Int. Cl. G05B 19/00

(52) U.S. Cl. 700/264; 901/50; 901/28

(57) ABSTRACT

A controller is provided to control operations of a robot provided with a robot body having operation axes to be controlled and an additional mechanism having an additional operation axis. The controller comprises a manual operation device, determination means and control means. The manual operation device enables a user to manually operate the operations of the robot body and the additional mechanism in parallel to each other. The determination means determines whether or not the additional mechanism is a linked state in operations with the robot body. The control means controls operation speeds of both the tip end of the operation axes of the robot body and the additional operation axis of the additional mechanism within a predetermined maximum speed, when the manual operation device is used to manually control the operations of the robot body and the additional mechanism in parallel to each other and the determination means determines that the additional mechanism is in a linked state in operations with the robot body.

### CROSS-REFERENCE TO RELATED APPLICATION

This application is based on and claims the benefit of priority from earlier Japanese Patent Application No. 2007-197439 flied Jul. 30, 2007, the description of which is incorporated herein by reference.

### BACKGROUND OF THE INVENTION

1. Technical Field of the Invention

The present invention relates to a controller used for a robot or a robot apparatus, and in particular, to a controller for controlling the operations of both the robot that has a robot body operating on robot axes (i.e., robot operation axes) and additional mechanisms operating an additional axes (i.e., additional operation axes) added to the robot axes.

2. Background Art

An industrial robotic system is configured to include a robot body (which is for example, an articulated robot arm), such as for conducting assembling work, and a robot control apparatus for controlling the axes of the robot body. Peripheral devices, such as a manually operated pendant called “teaching pendant”, are electrically connected to the robot control apparatus. The teaching pendant includes a display unit having a touch panel and a key operation device for carrying out various keystroke entries. The robotic system is configured, so that, in response to operator's operations at the teaching pendant, a robot program is activated and the robot body is manually operated (remote operated) during the teaching.

The robot control apparatus includes a control circuit configured essentially by a microcomputer, a servo control section having drive circuits for a plurality of robot axes, a power supply device, and an interface unit for performing high-speed data transmission between the interface unit and the peripheral devices. The control circuit is adapted to drive the robot operation axes (servomotors) of the robot body through the servo control unit, according to, for example, a robot program inputted and stored in advance, various data and parameters, as well as signals from the teaching pendant, to thereby operate and control the robot body.

In manually operating the robot body (during teaching operation) using the teaching pendant, the operator may often be required to perform operations in the vicinity of the work area of the robot body. Under such circumstances, ensuring safety is of importance to the operator. For this reason, as disclosed in Japanese Patent Laid-Open Publication No. 09-193060, the moving speed of the tip end of the robot body during a teaching process has been limited not to exceed a predetermined speed. In this case, according to ISO 10218-1, “The tool center point (TCP) speed of a robot must be limited to 250 mm/sec. or less at the maximum when the robot is manually operated.”

In the robotic system described above, additional operation axes for work in co-operation with the robot body are provided in addition to the robot body. Such additional operation axes include, for example, tools, such as a servomotor-driven hand, attached to the end of an arm, and a translation table (XY-translation device or rotary tables) at which the robot body is set up. A robot control apparatus may be configured so that the servo control section may include (or may be additionally provided with) a drive circuit for the additional operation axes, in addition to the drive circuit for controlling the axes of the robot body. With such a robot control apparatus, control of the robot body can be performed along with the control of the additional operation axes.

The robotic system having the additional operation axes as described above can control the speed of the robot body, per se, in manual operation so as not to exceed the predetermined maximum speed when the teaching process mentioned above is conducted. However, when the additional operation axes are operated in parallel to the robot body, such a robotic system may cause the speed of the tool center point (TCP), for example, to exceed the predetermined maximum speed. Thus, there has been a demand for fully reliable safety in the manual control of such a robotic system having additional operation axes.

### SUMMARY OF THE INVENTION

The present invention has been made in light of the circumstances described above, and has as its object to provide a robot control apparatus having a function of controlling additional operation axes (or additional axes) of additional mechanisms as well as the robot body per se, and fully ensuring safety in the manual operation.

In order to achieve the above object, as one aspect, the present invention provides a controller for a robot provided with a robot body having an operation axis to be controlled and an additional mechanism being added to the robot body and having an additional operation axis to be controlled, controlling. The controller comprises a manual operation device that enables a user to manually operate operations of the robot body and the additional mechanism in parallel to each other; determination means for determining whether or not the additional mechanism is a linked state in operations with the robot body; and control means for controlling operation speeds of both a tip end of the operation axis of the robot body and the additional operation axis of the additional mechanism within a predetermined maximum speed, when the manual operation device is used to manually control the operations of the robot body and the additional mechanism in parallel to each other and the determination means determines that the additional mechanism is in a linked state in operations with the robot body. For example, the control means including first limiting means for limiting the operation speeds of both the tip end of the operation axis of the robot body and the additional operation axis of the additional mechanism so that a sum of the operation speeds is below the predetermined maximum speed.

Thus, in the linked state where the operation of the additional mechanism (i.e., additional axis) influences the operation of the robot body, an added speed (a summed-up speed) between the speed (tip speed) of the additional operation axis of the additional mechanism and the tool center point (TCP) speed of the robot body, is adapted not to exceed the predetermined maximum speed in the manual operation mode for manipulating the robot body and the additional mechanism. In other words, it is so configured that, based on a predetermined speed limiting algorism, the added speed (that is, both individual speeds) is limited to a desired speed that can ensure safety. Accordingly, in the case where the robot body and the additional mechanism are operated in parallel to each other, the TCP speed of the robot body, for example, can be prevented from exceeding the maximum speed to fully ensure safety in the manual operation.

It is preferred that the control means includes second limiting means for limiting the operation speeds of both the tip end of the operation axis of the robot body and the additional operation axis of the additional mechanism so that each of the operation speeds is below the predetermined maximum speed, when the manual operation device is used to manually control the operations of the robot body in parallel to each other and the additional mechanism and the determination means determines that the additional mechanism is not in a linked state in operations with the robot body.

Thus, in the non-linked state, i.e. in the state where the operation of the additional operation axis does not influence the operation of the robot body, the tip of the additional operation axis of the additional mechanism and the TCP speed of the robot body are independently limited so as not to exceed the maximum speed. Accordingly, the speed of the additional mechanism and the TCP speed of the robot body are independently controlled to ensure safety, without being particularly lowered.

Further, the sum value of both speeds is a scalar quantity. Thus, the speed is calculated by adding the speed of the additional operation axis in scalar quantity to the TCP speed of the robot body in scalar quantity. Accordingly, the calculation process can be simplified, while at the same time, safety can be enhanced because the TCP speed of the robot body can be predicted as not exceeding the maximum speed.

### BRIEF DESCRIPTION OF THE DRAWINGS

In the accompanying drawings,

FIG. 1 is a schematic block diagram illustrating the electrical configuration of a robot control apparatus according to an embodiment of the present invention;

FIG. 2A is a flow diagram illustrating a procedure for setting link information;

FIG. 2B is a flow diagram Illustrating a procedure for limiting speed;

FIG. 3 illustrates a screen view for setting the link information;

FIGS. 4A to 4C each illustrate a different mode of, or different relationship between, a robot body and additional operation axes; and

FIGS. 5A and 5B each illustrate another embodiment of the present invention, i.e. a mode of, or relationship between, a robot body and additional operation axes, which is different from the ones shown in FIGS. 4A to 4C.

### DETAILED DESCRIPTION OF THE PREFERRED EMBODIMENTS

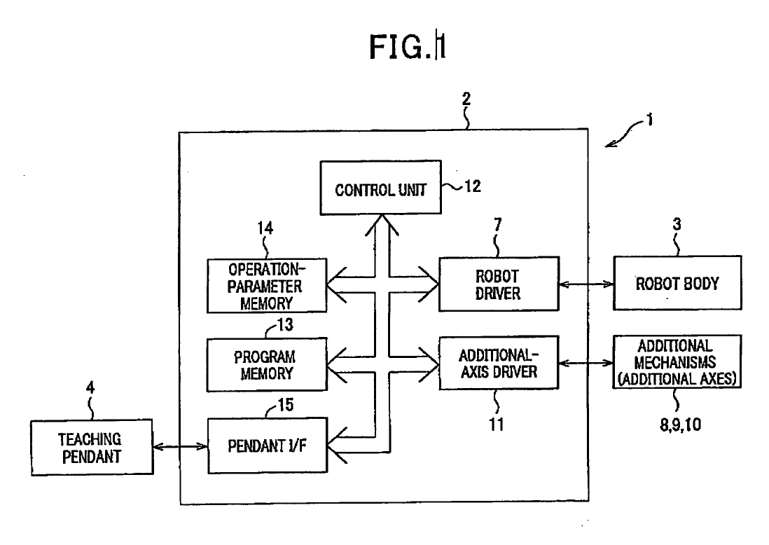

With reference to FIGS. 1 to 4A-4C, hereinafter will be described an embodiment of the present invention.

FIG. 1 is a schematic block diagram illustrating the configuration of a robotic system 1 for conducting assembling work, for example, according to the present embodiment of the present invention. A robot control apparatus 2 of the present embodiment is adapted to control a robot body 3, and at the same time, to control axes (i.e., one or more operation axes) additionally provided to the robot body 3. A teaching pendant 4, for example, as an external device is communicably connected to the robot control apparatus 2.

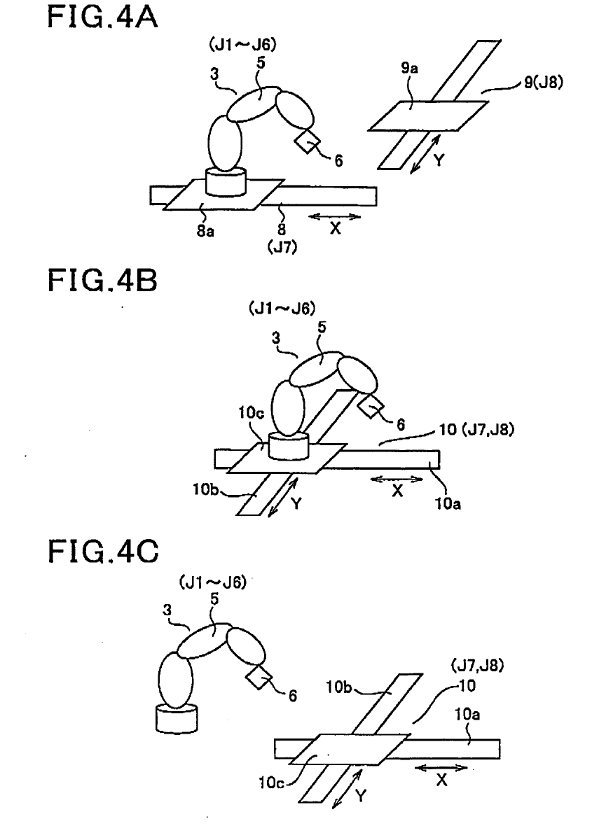

Each of FIGS. 4A to 4C schematically illustrates a mode of the robot body 3 and additional operation axes (or simply additional axes). To briefly explain, the robot body 3 is configured as a vertically articulated small robot having 6 axes, for example. The robot body 3 also has an arm 5 having 6 operation axes (J1 to J6) which are driven by respective servomotors. The arm 5 has a tip end having a work tool 6 (e.g., an air-driven chuck). As shown in FIG. 1, the servomotors for the operation axes (J1 to J6) are adapted to be controlled by robot drivers 7 (having six driving circuits) of the robot control apparatus 2.

In the mode of FIG. 4A, the robot body 3 is provided with an X-axis linear translation mechanism 8 (axis J7) and a Y-axis linear translation mechanism 9 (axis J8) as the additional operation axes. To briefly explain, the X-linear translation mechanism 8 is configured to have a movable body 8a which can be linearly translated in the X-axis direction, and a servomotor for freely translating the movable body 8a. Similarly, the Y-axis linear translation mechanism 9 is configured to have a movable body 9a which can be linearly translated in the Y-axis direction, and a servomotor for freely translating the movable body 9a.

In this mode, the base of the robot body 3 is mounted on the movable body 8a of the X-axis linear translation mechanism 8. Thus, the entire robot body 3 is ensured to be translated in the X-axis direction by the mechanism 8. The Y-axis linear translation mechanism 9 is provided independent of the robot body 3. It is so configured that a workpiece held on the movable body 9a, for example, can be translated in the Y-axis direction for working in cooperation with the robot body 3 (as well as the X-axis linear translation mechanism 8).

The modes illustrated in FIGS. 4B and 4C are each provided with an XY translation mechanism 10. As is known, the XY translation mechanism 10 includes an X-axis translation mechanical part 10a (axis J7) extending in the X-axis direction and a Y-axis translation mechanical part 10b (axis J8) orthogonal to the mechanical part 10a and extending in the Y-axis direction. The mechanical part 10a is configured to freely translate the mechanical part 10b in the X-axis direction by the driving of the servomotor. The mechanical part 10b is configured to freely translate a movable body 10c in the Y-axis direction by the driving of the servomotor.

In the mode illustrated in FIG. 4B, the base of the robot body 3 is mounted on the movable body 10c of the XY translation mechanism 10. Thus, the entire robot body 3 is ensured to be translated in the X- and Y-axis directions by the XY translation mechanism 10. In the mode illustrated in FIG. 4C, the XY translation mechanism 10 is provided independent of the robot body 3. Thus, it is so configured that a workpiece held on the movable body 10c can be translated in the X- and Y-axis directions for working in cooperation with the robot body 3.

As shown in FIG. 1, the servomotors for the additional operation axes J7 and J8 of the X- and Y-axis linear translation mechanisms 8 and 9, and the XY translation mechanism 10, are adapted to be controlled by an additional-axis driver 11 (two driving circuits in this case) of the robot control apparatus 2. The additional-axis driver 11 is configured to enable control up to four additional operation axes at the maximum.

The robot control apparatus 2 of the present embodiment is structured in a rectangular box-like frame (not shown) and has a microcomputer as a main component, with a control unit 12 being provided to control the entirety, as shown in FIG. 1. The robot control apparatus 2 includes the robot drivers 7 and the additional-axis driver 11 mentioned above, and a program memory 13, an operation-parameter memory 14 and a pendant interface (I/F) 15, which are all electrically and communicably connected to the control unit 12. Although not shown, the robot control apparatus 2 also includes an interface for establishing connection with the peripheral devices, such as a computer used for programming, as well as an image processor and a power supply.

The program memory 13 stores robot's programs inputted from and set by the teaching pendant 4 and the computer, for example. The operation-parameter memory 14 is adapted to store various data including target position data for the translation of the robot body 3 to a target position, and various parameters. As will be described later, the memory 14 is adapted to store predetermined link information to function as the link Information storing means. The teaching pendant 4 is configured to be connected to the pendant I/F 15 in a communicable manner.

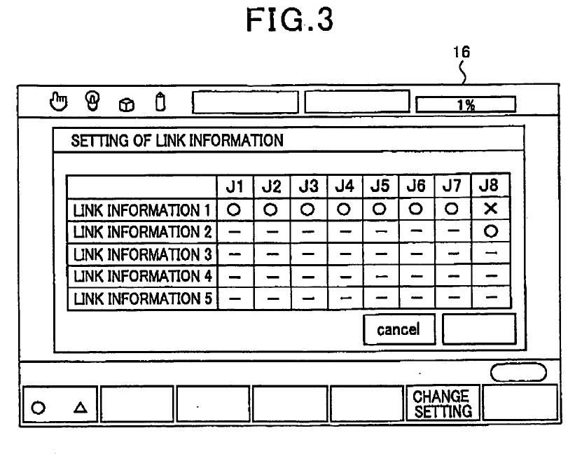

The teaching pendant 4 is structured to have a thin and substantially rectangular box-like shape, which is compact enough for an operator to carry by hand for manipulation. This shape is not specifically indicated in the FIG. The teaching pendant 4 has, at its center portion, a comparatively large display section 16 (see FIG. 3) structured by a color liquid display, for example, to indicate various screen views. A touch panel is provided at the surface of the display section 16. The teaching pendant 4 has various operation keys (mechanical switches) which are located along the periphery of the display section 16 to serve as a key operation section together with the touch panel. It is so configured that manipulation signals, for example, inputted from the key operation section are transmitted from the teaching pendant 4 to the robot control apparatus 2.

In this way, the operator is able to execute various functions using the teaching pendant 4, such as operation and setting of the robot body 3 and the additional operation axes (or additional axes) J7 and J8 of the translation mechanisms 8 to 10. Specifically, the operator can operate the key operation section to retrieve a list of robot programs stored (set) in advance for selection, and start (automatically operate) the robot body 3 and the additional operation axes J7 and J8. Also, the operator can set or change, for example, the various parameters of the robot programs.

Further, the operator can operate the key operation section to designate a manual operation mode. Operation of the key operation section in the manual operation mode enables the operator to conduct manual operation of the robot body 3 and the additional operation axes J7 and J8 of the translation mechanisms 8 to 10 to give them various instructions (or to conduct direct teaching) based on data such as of target positions (trajectory of motion). Thus, the teaching pendant 4 functions as the manipulating means.

The control unit 12, with its software configuration, is adapted to drive/control the servomotors of the axes (J1 to J6) of the robot body 3 through the robot drivers 7, in response, for example, to the robot programs stored in the program memory 13, the various data or parameters stored in the operation-parameter memory 14, or the manipulation signals from the teaching pendant 4. In addition, the control unit 12 is adapted to drive/control the servomotors of the additional operation axes J7 and J8 of the translation mechanisms 8 to 10 through the additional-axis driver 11. Thus, the assembling work of the workpiece, for example, can be automatically conducted with the cooperation between the robot body 3 and the additional operation axes J7 and J8 of the translation mechanisms 8 to 10.

In the present embodiment, when the operator operates the teaching pendant 4 to execute the manual operation mode for manually operating the robot body 3 and the additional operation axes J7 and J8 of the translation mechanisms 8 to 10, the control unit 12 of the robot control apparatus 2 is adapted to function as the speed limiting means for limiting the tool center point (TCP) speed of the robot body 3 so as not to exceed a predetermined maximum speed (e.g., 250 mm/sec.), in order to ensure safety.

In this regard, the operator can operate the teaching pendant 4 to preset link information for indicating whether or not the link is in a state where the operation of the additional operation axes J7 and J8 of the translation mechanisms 8 to 10 can influence the operation of the robot body 3. The preset link information is adapted to be stored in the operation-parameter memory 14. FIG. 3 illustrates the display section 16 of the teaching pendant 4, which is in a state of displaying a screen view for setting the link information. As can be seen, the individual operation axes J1 to J6 of the robot body 3 and the additional operation axis J7 are in a linked state and the additional operation axis J8 is in a non-linked state of not influencing the operation of the robot body 3.

In a linked state during the manual operation mode, one or both of the additional operation axes J7 and J8 of the translation mechanisms 8 to 10, if any, will influence the operation of the robot body 3 (robot operation axes J1 to J6). In such a case, the control unit 12 is adapted to limit the speed added (summed up) between the speeds (tip speeds) of the additional operation axes and the tool center point (TCP) speed of the robot body 3 (i.e., both of the speeds of the additional operation axes and the TCP speed of the tip end of the robot body 3), so as not to exceed the predetermined maximum speed, as will be described later with reference to the accompanied flow diagrams. In the present embodiment, the added speed to be limited refers to a speed resulting from addition between a speed of the additional operation axes in scalar quantity and the TCP speed of the robot body 3 in scalar quantity.

On the other hand, in a non-linked state of the manual operation mode, neither of the additional operation axes J7 and J8 of the translation mechanisms 8 to 10 will influence the robot body 3 (robot axes J1 to J6). In such a case, the control unit 12 is adapted to independently limit the speeds of the additional operation axes J7 and J8 and the TCP speed of the robot body 3, so as not to exceed the maximum speed. In the case where a plurality of additional operation axes are in a linked state, the control unit 12 limits the added speed of the plurality of additional operation axes not to exceed the maximum speed. Also, in the case where the plurality of additional operation axes are in a non-linked state, the additional operation axes are independently limited not to exceed the maximum speed.

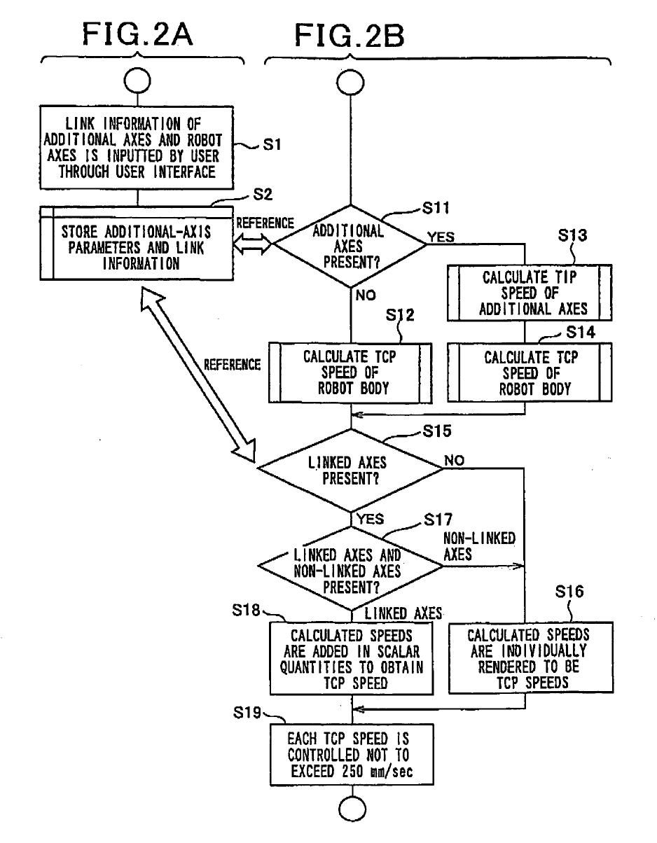

Hereinafter, the operation in the above configuration is described also referring to FIGS. 2A and 2B. FIG. 2A is a flow diagram illustrating a procedure for setting the link information, which is executed in the robot control apparatus 2. FIG. 2B is a flow diagram illustrating a procedure for limiting speed, which is executed by the control unit 12 in the manual operation mode. In setting the link information, a user (an operator) uses the teaching pendant 4 to indicate, on the display section 16, the screen view for setting the link information (see FIG. 3), and inputs the link information by operating the key operation section (step S1).

In this case, the parameters of the additional operation axes (e.g., radius of rotation if the additional axis in question is a rotary shaft) are inputted, if necessary. After completion of the link information, the inputted/set link information and the parameters of the additional operation axes are stored in the operation-parameter memory 14 (step S2). It should be appreciated that the link information does not necessarily have to be set using the teaching pendant 4, but may be set through a computer, for example, which can be connected to the robot control apparatus 2.

FIG. 3 illustrates an example of a screen view for setting the link information, with the indication of the link information in a table. The table shows link information 1, 2 . . . and 5 representing linking groups in the vertical direction, and axis numbers (J1 to J8) in the horizontal direction. The references J1 to J6 indicate the individual axes of the robot body 3, and the reference J7 onwards indicate the additional operation axes. In the link information, interlinked axes are represented by the symbol “0” and non-linked axes are represented by the symbol “x”. Also, the symbol “-” in the table represents that setting has already been done.

In the mode shown in FIG. 4A, the X-axis linear translation mechanism 8 (additional axis J7) is in a linked state of influencing the operation of the robot body 3. Accordingly, as shown in FIG. 3, the axes J1 to J7 are indicated by “0” in the link information 1. As a matter of course, all the robot axes J1 to J6 structuring the robot body 3 are in a linked state. The Y-axis linear translation mechanism 9 (additional axis J8), on the other hand, whose operation does not influence the operation of the robot body 3, is indicated by “x” as being in a non-linked state. The axis J8 is set as not being linked to other axes (solely indicated as “0”) in another independent group (link information 2).

In the mode shown in FIG. 4B, the axes J7 and J8 of the XY translation mechanism 10 are in a linked state of influencing the operation of the robot body 3, and thus all the axes J1 to J8 will be indicated by “0” in the link information 1. In the mode shown in FIG. 4C, the axes J7 and J8 of the XY translation mechanism 10 are in a non-linked state of not influencing the operation of the robot body 3, and thus the axes J1 to J6 will be indicated by “0” in the link information 1 while the additional operation axes J7 and J8 will be indicated by “x” as being in a non-linked state. In this case, the additional operation axes J7 and J8, which are linked with each other, will be indicated by “0” in the link information 2.

Once the link information is set as described above, the control (speed limitation) illustrated in the flow diagram of FIG. 2B is executed in the manual operation mode. Specifically, in the manual operation mode, the operator may operate the teaching pendant 4 to input command signals into the robot control apparatus 2, so that the robot body 3 and the additional operation axes J7 and J8 of the translation mechanisms 8 to 10 can be activated. Then, at step S11, reference is made to the link information stored in the operation-parameter memory 14 to determine the presence of additional operation axes.

If additional operation axes are not present (“NO” at step S11), the TCP (tool center point) speed of the robot body 3 is calculated at step S12. On the other hand, if additional operation axes are present (“YES” at step S11), the tip speeds of the additional operation axes are calculated at step S13, while at the same time the TCP speed of the robot body 3 is calculated at step S14. At the subsequent step S15, reference is made to the link information stored in the operation-parameter memory 14 to determine whether or not any of the additional operation axes are in the state of being linked to the robot body 3.

If no additional operation axes are in the state of being linked to the robot body 3 (non-linked state) (“NO” at step S15), the individual speeds, per se, calculated at steps S12 to S14 are regarded as being the TCP speeds, at step S16. On the other hand, if any of the additional operation axes are in the state of being linked to the robot body 3 (linked state) (“YES” at step S15), it is determined, at the subsequent step S17, as to the presence of linked axes and/or non-linked axes.

Based on the determination process of step S17, for each non-linked axis, the calculated speed, per se, is rendered to be the TCP speed, at step S16. For linked axes, the speed calculated by summing up the speeds obtained at steps S13 and S14 in scalar quantities, is rendered to be the TCP speed, at step S18. Then, at step S19, the robot body 3 and the additional operation axes are controlled so that each TCP speed will not exceed the maximum speed (e.g., 250 mm/sec.) and is set to a desired speed equal to or less than the maximum speed on the basis of a predetermined algorism previously stored in the program memory 13.

Thus, in the mode of FIG. 4A, for example, the sum of the TCP speed of the robot body 3 in scalar quantity and the tip speed of the X-axis linear translation mechanism 8 (speed of the movable body 8a) in scalar quantity, is limited so as not to exceed the maximum speed. Independent of this limitation, the tip speed of the Y-axis linear translation mechanism 9 (speed of the movable body 9a) is limited so as not to exceed the maximum speed.

In the mode of FIG. 4B, the sum of the TCP speed of the robot body 3 in scalar quantity and the tip speed of the XY translation mechanism 10 (speed of the movable body 10c) in scalar quantity, is limited so as not to exceed the maximum speed. Also, in the mode of FIG. 4C, the TCP speed of the robot body 3 is limited so as not to exceed the maximum speed. Independent of this limitation, the tip speed of the XY translation mechanism 10 is limited so as not to exceed the maximum speed.

As described above, according to the present embodiment, in the linked state where the operation of the additional operation axes J7 and J8 of the translation mechanisms 8 to 10 influences the operation of the robot body 3, all of the speeds of the additional operation axes J7 and J8 and the TCP speed of the robot body 3, are limited so as not to exceed the maximum speed in the manual operation mode for operating the robot body 3 and the additional operation axes J7 and J8. In other words, the added speed is limited so that safety can be ensured.

In the non-linked state, on the other hand, where the operation of the additional operation axes J7 and J8 of the translation mechanisms 8 to 10 does not influence the operation of the robot body 3, the speeds of the additional operation axes J7 and J8 and the TCP speed of the robot body 3 are independently limited so as not to exceed the maximum speed. Accordingly, the speeds of the additional operation axes J7 and J8 and the TCP speed of the robot body 3 are independently controlled to ensure safety, without being particularly lowered.

According to the present embodiment, parallel operation of the robot body 3 and the additional operation axes J7 and J8 of the translation mechanisms 8 to 10 may not permit the TCP speed of the robot body 3 to exceed the maximum speed, to thereby provide outstanding advantages of fully ensuring safety in the manual operation. In the present embodiment, in particular, the speed added between the additional operation axes J7 and J8 and the robot body 3 in a linked state is calculated by summing up the operation speeds of the former in scalar quantity and the TCP speed of the latter in scalar quantity to simplify the calculation process. In addition, since the TCP speed of the robot body 3, for example, can be predicted as not exceeding the maximum speed, safety can be further enhanced.

### Other Embodiments

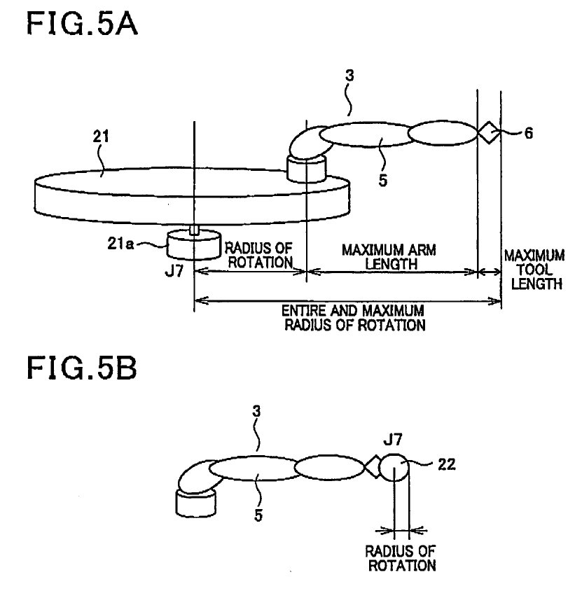

FIGS. 5A and 5B illustrate other embodiments of the present invention. Each of FIGS. 5A and 5B illustrates a mode provided with an additional axis which is different from the additional operation axes (i.e., linear axes) described in the above embodiment referring to FIGS. 4A to 4C. Specifically, in the mode of FIG. 5A, a disk type rotary table 21 (providing the additional operation axis J7) is used as the additional operation axis, and the robot body 3 is mounted on the rotary table 21. The rotary table 21 is configured to be rotatable by a servomotor 21a. The rotary table 21 is in a linked state of influencing the operation of the robot body 3.

When such a rotary table 21 is provided as the additional operation axis, such parameters as the radius of rotation and gear ratio of the additional axis are inputted as additional-axis parameters, at step S1 of the flow diagram illustrated in FIG. 2A. The tip speed of the additional axis can be readily calculated from the radius of rotation and the gear ratio (speed reducing ratio). Alternatively, in the mode illustrated in FIG. 5A, the parameter to be inputted may be the maximum radius of rotation which is a total of the radius of rotation of the rotary table 21, per se, the maximum length of the arm 5 of the robot body 3, and the maximum length of the work tool 6. Thus, all of the speeds of the robot body 3 and the rotary table 21 can be readily calculated.

The mode illustrated in FIG. 5B uses a servo-hand 22 as the additional operation axis J7. The servo-hand 22 serves as a work tool attached to the end of the arm 5 of the robot body 3, being provided with a rotary shaft which is driven by a servomotor, not shown. The servo-hand 22 (providing the additional operation axis J7) is in a linked state of influencing the operation of the robot body 3. In this case, the radius of rotation of only the servo-hand 22 is inputted as the additional-axis parameter.

The embodiments described above have used the teaching pendant 4 as the manipulating means for manually operating the robot body and the additional operation axes. Alternative to the teaching pendant 4, a computer (e.g. keyboard and mouse) may be used for the manual operation. Also, the teaching pendant may have a relatively simple configuration without having the display section 16. In addition, the link information may be set using a device separate from the device for manually operating the robot body and the additional operation axes.

In the foregoing embodiments, the robot body is not limited to one having the articulated type of arm, but may be provided a single joint type of arm. In the foregoing embodiments, as the additional mechanisms, two or more of the X-axis linear translation mechanism 8, the Y-axis linear translation mechanism 9, the XY translation mechanism 10, the disk type rotary table 21, and the servo-hand 22 may be combined in a proper desired manner.

Finally, various modifications may be made, such as in the entire configuration of the robotic system 1, the configuration of the robot body 3 and the shape and structure of the robot control apparatus 2, to adequately change and implement the present invention without departing from the spirit of the present invention.

What is claimed is:

1. A controller for a robot provided with a robot body having an operation axis to be controlled and an additional mechanism being added to the robot body and having an additional operation axis to be controlled, controlling:
a manual operation device that enables a user to manually operate operations of the robot body and the additional mechanism in parallel to each other;
determination means for determining whether or not the additional mechanism is a linked state in operations with the robot body; and
control means for controlling operation speeds of both a tip end of the operation axis of the robot body and the additional operation axis of the additional mechanism within a predetermined maximum speed, when the manual operation device is used to manually control the operations of the robot body and the additional mechanism in parallel to each other and the determination means determines that the additional mechanism is in a linked state in operations with the robot body.

2. The controller of claim 1, wherein the control means including first limiting means for limiting the operation speeds of both the tip end of the operation axis of the robot body and the additional operation axis of the additional mechanism so that a sum of the operation speeds is below the predetermined maximum speed.

3. The controller of claim 2, wherein the sum value is a scalar quantity.

4. The controller of claim 1, wherein the predetermined maximum speed is a speed of 250 mm/sec.

5. The controller of claim 2, wherein the control means includes second limiting means for limiting the operation speeds of both the tip end of the operation axis of the robot body and the additional operation axis of the additional mechanism so that each of the operation speeds is below the predetermined maximum speed, when the manual operation device is used to manually control the operations of the robot body in parallel to each other and the additional mechanism and the determination means determines that the additional mechanism is not in a linked state in operations with the robot body.

6. The controller of claim 5, wherein the determination means comprises a storage for storing information showing whether or not additional mechanism is in the linked state in operations with the robot body and reading means for reading from the storage the information for the limitations performed by the first and second limiting means.

7. The controller of claim 1, wherein the arm is an articulated type of arm.

8. The controller of claim 7, wherein the control means including limiting means for limiting the operation speeds of both the tip end of the operation axis of the robot body and the additional operation axis of the additional mechanism so that a sum of the operation speeds is below the predetermined maximum speed.

9. The controller of claim 8, where the control means includes limiting means for limiting the operation speeds of both the tip end of the operation axis of the robot body and the additional operation axis of the additional mechanism so that each of the operations speeds is below the predetermined maximum speed, when the manual operation device is used to manually control the operations of the robot body in parallel to each other and the additional mechanism and the determination means determines that the mechanism is not in a linked state in operations with the robot body.

10. The controller of claim 9, wherein the sum value is a scalar quantity.

11. The controller of claim 10, wherein the robot body comprises an arm and the additional mechanism includes at least one of an X-axis liner move mechanism, a Y-axis liner move mechanism, an XY move mechanism, a rotation table, and a servo hand added to a tip end of the arm.

12. A method for controlling operations of a robot provided with a robot body having an operation axis to be controlled and an additional mechanism being added to the robot body and having an additional operation axis to be controlled and, controlling steps of:
determining whether or not the additional mechanism is a linked state in operations with the robot body; and
controlling operation speeds of both a tip end of the operation axis of the robot body and the additional operation axis of the additional mechanism within a predetermined maximum speed, when the operations of the robot are manually operated and it is determined that the additional mechanism is in a linked state in operations with the robot body.

13. The method of claim 12, wherein the control step includes a step for limiting the operation speeds of both the tip end of the operation axis of the robot body and the additional operation axis of the additional mechanism so that a sum of the operation speeds is below the predetermined maximum speed.

14. The method of claim 13, wherein the control step includes a further step for limiting the operation speeds of both the tip end of the operation axis of the robot body and the additional operation axis of the additional mechanism so that each of the operation speeds is below the predetermined maximum speed, when the operations of the robot are manually operated and it is determined that the additional mechanism is not in a linked state in operations with the robot body.
